(19) United States
(12) Patent Application Publication
(10) Pub. No.: US 2006/0285290 A1
(43) Pub. Date: Dec. 21, 2006

(54) Electronic system redundant heat dissipating unit operability inspecting method and system

(75) Inventors: Wh Shih, Taipei (TW); Chin-Fong Pan, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/153,459

(22) Filed: Jun. 15, 2005

(51) Int. Cl. G06F 1/20

(52) U.S. Cl. 361/687

(57) ABSTRACT

An electronic system redundant heat dissipating unit operability inspecting method and system is proposed, which is designed for use in conjunction with an electronic system equipped with a main heat dissipating unit and at least one redundant heat dissipating unit for providing the redundant heat dissipating unit with a periodic operability checking function; and which is characterized by the capability of periodically checking whether the redundant heat dissipating unit is in good operable state at predefined intervals, and if not, capable of generating an abnormal condition notification message in human-perceivable form for the purpose of notifying the system management personnel of the electronic system to take necessary maintenance tasks on the failed redundant heat dissipating unit. This feature ensures the electronic system to have an uninterrupted heat dissipating capability when the main heat dissipating unit fails.

### BACKGROUND OF THE INVENTION

1. Field of the Invention

This invention relates to electronic system heat dissipating technology, and more particularly, to an electronic system redundant heat dissipating unit operability inspecting method and system which is designed for use in conjunction with an electronic system equipped with a main heat dissipating unit and at least one redundant heat dissipating unit for providing the redundant heat dissipating unit with a periodic operability checking function that periodically check whether the redundant heat dissipating unit is in good operable state so that in the event of a failure to the main heat dissipating unit, the redundant heat dissipating unit can reliably replace the failed main heat dissipating unit.

2. Description of Related Art

Electronic systems typically produce large amounts of heat during operation due to consumption of electrical power, and if this heat is undissipated, it would result in burnout of electrical components or chips (such as CPUs), thus causing the electronic system to shut down or fail to operate normally. One solution to this problem is to mount heat-dissipating devices, such as electrical fan units, for dissipating heat in the electronic system during operation. For example, computer units such as network servers and desktop computers are typically equipped with one or more fan-based heat-dissipating units for use to generate air streams to blow away the heat generated by the network servers and desktop computers during operation.

In actual implementations, in order to assure the heat-dissipating capability, a network server is typically equipped with two or more heat dissipating units, including a main heat dissipating unit and at least one redundant heat dissipating unit, wherein in normal conditions the main heat dissipating unit is operated to provide a heat dissipating function to the network server while the redundant heat dissipating unit is put in standby mode so that in the event that the main heat dissipating unit fails, the redundant heat dissipating unit can immediately operated to replace the failed main heat dissipating unit. This ensures the network server to have an uninterrupted heat dissipating capability.

In practice, however, since a redundant heat dissipating unit would typically remain in standby mode for a long period until the failure of the main heat dissipating unit, the redundant heat dissipating unit could be possibly in inoperable state due to some unknown reasons during the standby period. In this case, in the event of a failure of the main heat dissipating unit, since the redundant heat dissipating unit is already in inoperable state, the redundant heat dissipating unit will be unable to fulfill its backup duty to replace the main heat dissipating unit. As a result, the network server may suffer from thermal damage due to overheating when the main heat dissipating unit fails.

### SUMMARY OF THE INVENTION

It is therefore an objective of this invention to provide an electronic system redundant heat dissipating unit operability inspecting method and system which is capable of providing a redundant heat dissipating unit with a periodic operability checking function that periodically check whether the redundant beat dissipating unit is in good operable state so that in the event of a failure to the main heat dissipating unit, the redundant heat dissipating unit can reliably replace the failed main heat dissipating unit.

The electronic system redundant heat dissipating unit operability inspecting method and system according to the invention is designed for use in conjunction with an electronic system equipped with a main heat dissipating unit and at least one redundant heat dissipating unit for providing the redundant heat dissipating unit with a periodic operability checking function that periodically check whether the redundant heat dissipating unit is in good operable state so that in the event of a failure to the main heat dissipating unit, the redundant heat dissipating unit can reliably replace the failed main heat dissipating unit.

In terms of method, the invention comprises: (1) generating an inspection enable message at perdefined time intervals; (2) responding to the inspection enable message by activating the redundant heat dissipating unit to start operation; (3) when the redundant heat dissipating unit is started to operate, checking whether the redundant heat dissipating unit operates normally; and if NO, issuing an abnormal condition notification enable message; and (4) responding to the abnormal condition notification enable message by generating an abnormal condition notification message in human-perceivable form.

In terms of system, the invention comprises: (a) a timing module, which is capable of generating an inspection enable message at perdefined time intervals; (b) a redundant heat dissipating unit activating module, which is capable of responding to the inspection enable message by activating the redundant heat dissipating unit to start operation; (c) a redundant heat dissipating unit operating condition checking module, which is capable of being activated when the redundant heat dissipating unit is started to operate by the redundant heat dissipating unit activating module to check whether the redundant heat dissipating unit operates normally; and if NO, capable of issuing an abnormal condition notification enable message; and (d) an abnormal condition notification module, which is capable of being activated in response to the abnormal condition notification enable message issued by the abnormal condition notification module to thereupon generate an abnormal condition notification message in human-perceivable form.

The electronic system redundant heat dissipating unit operability inspecting method and system according to the invention is characterized by the capability of periodically checking whether the redundant heat dissipating unit is in good operable state at predefined intervals, and if not, capable of generating an abnormal condition notification message in human-perceivable form for the purpose of notifying the system management personnel of the electronic system to take necessary maintenance tasks on the failed redundant heat dissipating unit. This feature ensures the electronic system to have an uninterrupted heat dissipating capability when the main heat dissipating unit fails.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and modularized object-oriented component model of the electronic system redundant heat dissipating unit operability inspecting system according to the invention.

### DETAILED DESCRIPTION OF PREFERRED EMBODIMENTS

The electronic system redundant heat dissipating unit operability inspecting method and system according to the invention is disclosed in full details by way of preferred embodiments in the following with reference to the accompanying drawings.

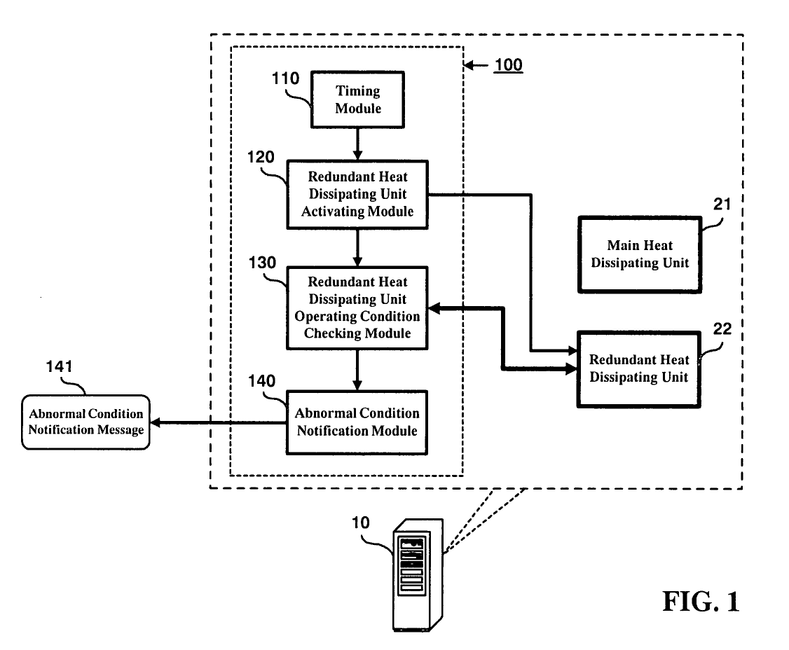

FIG. 1 is a schematic diagram showing the application architecture and modularized object-oriented component model of the electronic system redundant heat dissipating unit operability inspecting system according to the invention (as the part enclosed in the dotted box indicated by the reference numeral 100). As shown, the electronic system redundant heat dissipating unit operability inspecting system of the invention 100 is designed for use in conjunction with an electronic system 10 (such as a network server, a desktop computer, and the like) that is equipped with a main heat dissipating unit 21 and at least one redundant heat dissipating unit 22 for providing the redundant heat dissipating unit 22 with a periodic operability checking function that periodically check whether the redundant heat dissipating unit 22 is in good operable state, so that in the event of a failure to the main heat dissipating unit 21, the redundant heat dissipating unit 22 can reliably replace the failed main heat dissipating unit 21. In this embodiment, the main heat dissipating unit 21 and the redundant heat dissipating unit 22 are both fan-based type, but the invention is also applicable to various other types of heat-dissipating devices, such as coolant-based heat-dissipating devices.

In actual operation, the electronic system redundant heat dissipating unit operability inspecting system of the invention 100 is capable of providing the redundant heat dissipating unit 22 with a periodic operability checking function to check whether the redundant heat dissipating unit 22 is in good operable state. If not, the electronic system redundant heat dissipating unit operability inspecting system of the invention 100 will generate an abnormal condition notification message 141 in human-perceivable form, such as displaying the abnormal condition notification message 141 in text form through a liquid crystal display unit (not shown), generating a sound alarm through a buzzer (not shown), to name just a few, for the purpose of notifying the system management personnel of the electronic system 10 to take necessary maintenance tasks on the failed redundant heat dissipating unit 22. In addition, the abnormal condition notification module 140 can log the abnormal condition notification message 141 as an abnormal event and store the message of the logged abnormal event in non-volatile random access memory module (not shown) or transfer the message of the logged abnormal event via a modem or network server (not shown) such as LAN (Local Area Network), Internet, intranet, extranet, and so on, to a remote network station (not shown) for the purpose of notifying remotely-located system management personnel of the electronic system 10 to take necessary maintenance tasks on the failed redundant heat dissipating unit 22

As shown in FIG. 1, the modularized object-oriented component model of the electronic system redundant heat dissipating unit operability inspecting system of the invention 100 comprises: (a) a timing module 110; (b) a redundant heat dissipating unit activating module 120; (c) a redundant heat dissipating unit operating condition checking module 130; and (d) an abnormal condition notification module 140.

The timing module 110 is capable of generating an inspection enable message at perdefined time intervals, such as 24 hours, and transferring the inspection enable message to the redundant heat dissipating unit activating module 120. In network application, for example, the timing module 110 can be realized by using a watchdog module integrated in a network server which can be set by the user to generate an interrupt signal at a period of 24 hours (i.e., at the same time everyday).

The redundant heat dissipating unit activating module 120 is capable of listening to the inspection enable message generated by the timing module 110 and responding to this inspection enable message by activating the redundant heat dissipating unit 22 to start operation.

The redundant heat dissipating unit operating condition checking module 130 is capable of being activated when the redundant heat dissipating unit 22 is started to operate by the redundant heat dissipating unit activating module 120 to thereupon check whether the redundant heat dissipating unit 22 operates normally, for example whether the fan (not shown) of the redundant heat dissipating unit 22 rotates properly, whether the generated air-blowing capacity is sufficient, and so on. If YES, the current operability inspecting procedure is completed; whereas if NO, the redundant heat dissipating unit operating condition checking module 130 will issue an abnormal condition notification enable message to the abnormal condition notification module 140.

The abnormal condition notification module 140 is capable of being activated in response to the abnormal condition notification enable message issued by the abnormal condition notification module 140 to thereupon generate an abnormal condition notification message 141 in human-perceivable form, such as displaying the abnormal condition notification message 141 in text form through a liquid crystal display unit (not shown), generating a sound alarm through a buzzer (not shown), to name just a few, for the purpose of notifying the system management personnel of the electronic system 10 to take necessary maintenance tasks on the failed redundant heat dissipating unit 22. In addition, the abnormal condition notification module 140 can log the abnormal condition notification message 141 as an abnormal event and store the message of the logged abnormal event in non-volatile random access memory module (not shown) or transfer the message of the logged abnormal event via a modem or network server (not shown) such as LAN (Local Area Network), Internet, intranet, extranet, and so on, to a remote network station (not shown) for the purpose of notifying remotely-located system management personnel of the electronic system 10 to take necessary maintenance tasks on the failed redundant heat dissipating unit 22.

The operation of the electronic system redundant heat dissipating unit operability inspecting system of the invention 100 in actual application is described in the following.

As shown in FIG. 1, when the electronic system 10 is started to operate, it also start the main heat dissipating unit 21 to operate and thereby provide a heat-dissipating function to the electronic system 10; and meanwhile the redundant heat dissipating unit 22 is set in standby mode. In the same time, the electronic system redundant heat dissipating unit operability inspecting system of the invention 100 is also activate, whereby the timing module 110 is activated to count time and capable of generating an inspection enable message at perdefined time intervals, such as 24 hours, and transferring the inspection enable message to the redundant heat dissipating unit activating module 120. In response, the redundant heat dissipating unit activating module 120 activates the redundant heat dissipating unit 22 to start operation, and meanwhile the redundant heat dissipating unit operating condition checking module 130 is activated to check whether the redundant heat dissipating unit 22 operates normally, for example whether the fan (not shown) of the redundant heat dissipating unit 22 rotates properly, whether the generated air-blowing capacity is sufficient, and so on. If YES, the current operability inspecting procedure is completed; whereas if NO, the redundant heat dissipating unit operating condition checking module 130 will issue an abnormal condition notification enable message to the abnormal condition notification module 140. In response, the abnormal condition notification module 140 generate an abnormal condition notification message 141 in human-perceivable form, such as displaying the abnormal condition notification message 141 in text form through a liquid crystal display unit (not shown), generating a sound alarm through a buzzer (not shown), to name just a few, for the purpose of notifying the system management personnel of the electronic system 10 to take necessary maintenance tasks on the failed redundant heat dissipating unit 22. In addition, the abnormal condition notification module 140 can log the abnormal condition notification message 141 as an abnormal event and store the message of the logged abnormal event in non-volatile random access memory module (not shown) or transfer the message of the logged abnormal event via a modem or network server (not shown) such as LAN (Local Area Network), Internet, intranet, extranet, and so on, to a remote network station (not shown) for the purpose of notifying remotely-located system management personnel of the electronic system 10 to take necessary maintenance tasks on the failed redundant heat dissipating unit 22.

In conclusion, the invention provides an electronic system redundant heat dissipating unit operability inspecting method and system for use with an electronic system equipped with a main heat dissipating unit and at least one redundant heat dissipating unit, and which is characterized by the capability of periodically checking whether the redundant beat dissipating unit is in good operable state at predefined intervals, and if not, capable of generating an abnormal condition notification message in human-perceivable form for the purpose of notifying the system management personnel of the electronic system to take necessary maintenance tasks on the failed redundant heat dissipating unit. This feature ensures the electronic system to have an uninterrupted heat dissipating capability when the main heat dissipating unit fails. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An electronic system redundant beat dissipating unit operability inspecting method for use on an electronic system equipped with a main heat dissipating unit and at least one redundant heat dissipating unit for providing the redundant heat dissipating unit with a periodic operability checking function;
the electronic system redundant heat dissipating unit operability inspecting method comprising:
generating an inspection enable message at perdefined time intervals;
responding to the inspection enable message by activating the redundant heat dissipating unit to start operation;
when the redundant heat dissipating unit is started to operate, checking whether the redundant heat dissipating unit operates normally; and if NO, issuing an abnormal condition notification enable message; and
responding to the abnormal condition notification enable message by generating an abnormal condition notification message in human-perceivable form.

2. The electronic system redundant heat dissipating unit operability inspecting method of claim 6, wherein the electronic system is a network server.

3. The electronic system redundant heat dissipating unit operability inspecting method of claim 6, wherein the electronic system is a desktop computer.

4. The electronic system redundant heat dissipating unit operability inspecting method of claim 6, wherein the redundant heat dissipating unit is a fan-based heat-dissipating device.

5. The electronic system redundant heat dissipating unit operability inspecting method of claim 6, wherein the redundant heat dissipating unit is a coolant-based heat-dissipating device.

6. An electronic system redundant heat dissipating unit operability inspecting system for use with an electronic system equipped with a main heat dissipating unit and at least one redundant heat dissipating unit for providing the redundant heat dissipating unit with a periodic operability checking function;
the electronic system redundant heat dissipating unit operability inspecting system comprising:
a timing module, which is capable of generating an inspection enable message at perdefined time intervals;
a redundant heat dissipating unit activating module, which is capable of responding to the inspection enable message by activating the redundant heat dissipating unit to start operation;
a redundant heat dissipating unit operating condition checking module, which is capable of being activated when the redundant heat dissipating unit is started to operate by the redundant heat dissipating unit activating module to check whether the redundant heat dissipating unit operates normally; and if NO, capable of issuing an abnormal condition notification enable message; and
an abnormal condition notification module, which is capable of being activated in response to the abnormal condition notification enable message issued by the abnormal condition notification module to thereupon generate an abnormal condition notification message in human-perceivable form.

7. The electronic system redundant heat dissipating unit operability inspecting system of claim 6, wherein the electronic system is a network server.

8. The electronic system redundant heat dissipating unit operability inspecting system of claim 6, wherein the electronic system is a desktop computer.

9. The electronic system redundant heat dissipating unit operability inspecting system of claim 6, wherein the redundant heat dissipating unit is a fan-based heat-dissipating device.

10. The electronic system redundant heat dissipating unit operability inspecting system of claim 6, wherein the redundant heat dissipating unit is a coolant-based heat-dissipating device.
